(19) United States
(12) Patent Application Publication
(10) Pub. No.: US 2014/0000236 A1
(43) Pub. Date: Jan. 2, 2014

(54) COMBUSTOR

(71) Applicant: Jorge Alejandro LOPEZ POY, Buenos Aires (AR)

(72) Inventor: Jorge Alejandro LOPEZ POY, Buenos Aires (AR)

(21) Appl. No.: 13/670,834

(22) Filed: Nov. 7, 2012

(30) Foreign Application Priority Data
Jul. 2, 2012 (AR) 20120102391

(51) Int. Cl. F02C 3/20; F23G 5/16; F23B 10/00

(52) U.S. Cl. 60/39.461; 110/208; 110/254

(57) ABSTRACT

A combustor of the type used for producing energy using biomass as fuel, wherein the combustor comprises at least one cyclonic and refractory combustion chamber, said combustion chamber being of a compact size, said combustor defines a means for carrying out the process of pyrolyzing, gasification, reduction and oxidation instantaneously, preheating means define the air temperature which is in a fuel-air ratio close to the stoichiometric Δ=1, stabilizing means define the automatic control of the system by regulating the air and fuel flow. The biomass to be used as fuel in the present invention must be of millimetric size and the humidity content must not be greater than 30%. It can be used any kind of dry matter of vegetable or peat of different calorific power. The heat generated may be used in all conventional techniques.

### FIELD OF THE INVENTION

The present invention relates to a combustor of the type used for producing energy using biomass as fuel.

### BACKGROUND OF THE INVENTION

There is currently a great variety of equipment for burning biomass, derived from most equipment that were designed to burn coal and were modified afterwards. Others have been designed specifically for biomass, being the most common fixed bed and fluidized bed. The fluidized bed combustors do not generally perform a complete combustion, therefore are being called gasifiers due to that fact that they are already generating free CO and H that are being combusted in a second stage. These facilities are very large and can only be conceived for power plants or gas generation on a large scale. In small scale fixed beds are used in boilers, these systems require gas cleaning for trapping particulate and tar. In some cases the biomass fuel is combusted with other like natural gas, fuel oil or coal equipment were modified for this purpose, in all cases being stationary installations.

Different devices are also known in patent U.S. Pat. No. 2,717,563 to BABCOCK & WILCOX CO. The invention relates to the construction and operation of a cyclone furnace for the combustion of ash-containing solid granular state to a temperature above the melting temperature of the ash, the ash removing residual achieving fuel furnace as liquid. Furthermore, it is also known patent U.S. Pat. No. 5,572,956, also on behalf of Babcock & Wilcox CO. This particular patent discloses a cyclone after-burner for cyclone reburn NO.sub.x reduction in a furnace has a retractable fuel pipe inside a lance extending along the cylindrical axis of the cyclone to a point near the re-entrant throat. The lance has a water-cooled jacket that is refractory covered to reduce heat absorption. The fuel pipe is adapted to provide gas, oil or pulverized coal for combustion in the furnace.

Unfortunately, the above mentioned devices have not been developed exclusively for use biomass, but that they attempt to provide a solution to the existing problems in the separation of the ash using the cyclone effect.

### SUMMARY OF THE INVENTION

It is therefore an object of the present invention provide a combustor capable of using biomass as fuel, achieving clean emissions. The innovation consists in the direct combustion of biomass under conditions of high temperature and high turbulence within refractory cyclonic combustion chambers, obtaining a complete dissociation of the large molecules containing carbon and hydrogen leaving as a result, only inert solid ash for one side, and clean hot gases on the other. The first chamber comprises a reducing atmosphere while the second comprises a slightly oxidizing atmosphere. The combustor has an automatic control system which maintains the stability of the system to power various schemes and variations in the characteristics of the biomass. This system allows, by means of a microprocessor, the control of the dosage of biomass and air flows so that the equipment adapts to the power variations and automatically to any changes in the calorific value of the fuel and/or different humidity content.

The biomass to be used as fuel in the present invention must be of millimetric size and the humidity content must not be greater than 30%. It can be used any kind of dry matter of vegetable or peat of different calorific power. The heat generated may be used in all conventional techniques, being in particular very suitable for the Brayton cycle utilizing a gas turbine direct circuit combustor effluents.

It is therefore an object of the present invention to provide a combustor of the type used for producing energy using biomass as fuel, wherein the combustor comprises at least one cyclonic and refractory combustion chamber, said combustion chamber being of a compact size, said combustor defines a means for carrying out the process of pyrolyzing, gasification, reduction and oxidation instantaneously, preheating means define the air temperature which is in a fuel-air ratio close to the stoichiometric Δ=1, stabilizing means define the automatic control of the system by regulating the air and fuel flow.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a schematic of biomass combustor object of the present invention incorporated in a thermodynamic cycle, and

FIG. 2 is a top plan view of the FIG. 1 combustor.

### DESCRIPTION OF THE PREFERRED EMBODIMENTS

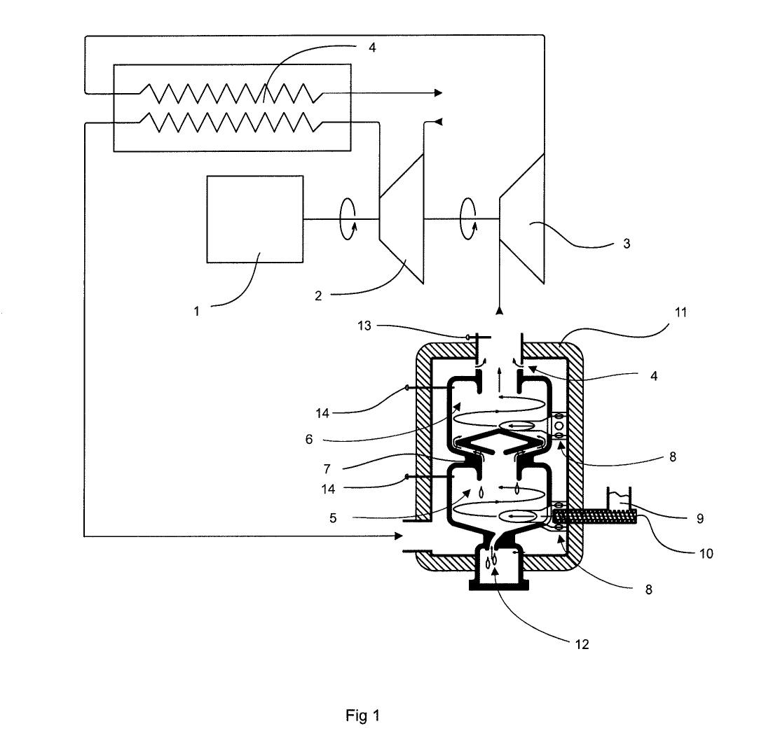

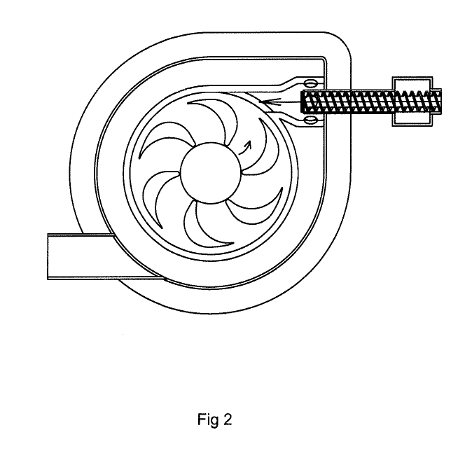

FIGS. 1 and 2 shows the compact biomass combustor object of the present invention, which operates with one or more refractory chambers at very high temperature and turbulence to perform in a direct and clean manner the process of pyrolyzing, gasification, reduction and instantly oxidation. To achieve the high temperature air is preheated and working conditions are with an air-fuel ratio close to the stoichiometric Δ=1.

In this particular embodiment, the following reference numbers indicate different elements of the thermodynamic cycle and parts of the combustor object of the present invention. Accordingly, the cycle elements are, an electric generator 1, a compressor 2, a turbine 3, a regenerator 4. The combustor comprises several parts; reference number 5 is intended to indicate a high density of solids cyclonic combustor chamber Δ≦1, whereas reference number 6 indicates a low density of solids cyclonic combustor chamber Δ≧1, reference number 7 indicates the ceramic refractory material. The combustor also comprises proportional control valves 8, biomass fuel 9, a metering screw feeder 10, heat insulation 11, ash 12, a thermocouple 13 and a high temperature thermocouple and lambda sensor 14.

The biomass combustor has its gas circulation in the refractory chambers cyclone shaped to separate the uncombusted particles and ash from the effluent gas flow free from solids. The uncombusted particles circulate until they become gas, the remaining ash particles stick in a molten state to the refractory walls and flow by gravity to the ash deposit. The cyclonic axis orientation can be vertical, horizontal, or any other position, providing that the ash exit port is always in the lowest point of the system.

Due to the characteristics of the clean effluent, this biomass combustor can be used in a direct Brayton cycle (turbine combustor fed with effluents) without an exchanger and achieving a high thermodynamic efficiency, allowing to have a very compact system replacing at equal or better ratio, weight and volume, power, at internal combustion engines. To achieve controlling the gas temperature entering the turbine, keeping a much higher gas temperature in the combustor, a portion of the flow of compressed gases from the Bryton cycle are deviated by bypass, mixing them again before entering the turbine.

The biomass combustor has one or several chambers working in an air-fuel ratio close to the stoichiometric Δ=1. Preferably it uses two chambers, the first chamber with a reducing atmosphere Δ≦1, Δ=0.8 to 0.9 and the second chamber where it provides a new dose of air creating an oxidizing atmosphere Δ≧1, Δ=1.1 to 1.2, achieving low formation of nitrogen oxides and a high temperature combustion.

The biomass combustor has the combustion chambers pressurized at an equal to or greater than the atmospheric pressure. The volumetric efficiency is greater at a higher pressure, preferably from 0.25 to 0.4 MPa in a single compression stage Brayton cycle, and from 0.8 to 1.2 MPa in a double compression stage Brayton cycle.

The biomass combustor has a control system to maintain system stability at different power regimes and variations in the characteristics of the biomass so as to caloric capacity and humidity content. The system consists of several sensors, a lambda sensor and a thermocouple in the gas exit port of each combustion chamber, and a thermocouple at the exit of the mixing bypass. A biomass feed system variable flow is also included, and a servo actuated butterfly valve in each chamber for regulating the airflow. A microprocessor handles all control loops, adjusting the fuel flow by varying the dosage system for controlling temperature, and regulating the air flow by varying the position of a servo operated butterfly valve in each chamber to control the optimal lambda value in each chamber. By means of the microprocessor, the system allows controlling the dosing of biomass and regulates the air flow so that the equipment automatically adapts to any other fuel calorific value, and with different humidity content.

Due to its design, the biomass combustor design requires no special preparation of the biomass to be used as a fuel. The only requirement is that the biomass must not have excessive humidity and milled to a millimeter particle size which is a simple and economical feature in the case of use of stubble, fodder or peat, requiring more energy in the case of wood. These particles may or may not be compacted into pellets or ammunition in order to facilitate fluidity and reduce the volume. The biomass feed system which feeds the combustor may be equipped with a pellet or ammunition grinder at its entrance in order to create millimeter particles.

The object of the present invention allows the direct and clean combustion of biomass, in a small cyclonic combustion chamber with refractory walls; the chamber may have a two or more cyclonic stages, preferably two. In the first chamber the preheated air is supplied along with millimeter size particles of biomass carried by the airflow in a Δ≦1 ratio, achieving a reducing atmosphere at the combustion. A second chamber with additional air completes the combustion of CO and H with a ratio of Δ≧1. This ensures the reduced formation of nitrogen oxide despite the high temperatures in the chambers.

The reduced numbers of particles that may escape the first cyclone disappear in the second stage completely burned. To improve the volumetric efficiency is advantageous to work with a pressurized chamber, which is optimal in a Brayton cycle, where the combustion chamber works at a pressure between the compressor and the turbine, being only a part of the air flow passing through the chamber combustion and mixing downstream before entering the turbine to prevent the formation of nitrogen oxides. The ash produced in the chamber is in liquid state and sticks to the walls by the centrifugal effect of the cyclone flowing slowly by gravity towards a sump at the lowest point.

The combustion of biomass solids takes place in a very short period, the rate being proportional to the combustion chamber temperature and turbulence, and inversely proportional to the particle size of biomass. This effect provides a good stability in the chamber considering that a higher mass flow increases the temperature and turbulence reducing the combustion time.

1. A combustor of the type used for producing energy using biomass as fuel, wherein the combustor comprises at least one cyclonic and refractory combustion chamber, said combustion chamber being of a compact size, said combustor defines a means for carrying out the process of pyrolyzing, gasification, reduction and oxidation instantaneously, preheating means define the air temperature which is in a fuel-air ratio close to the stoichiometric Δ=1, stabilizing means define the automatic control of the system by regulating the air and fuel flow.

2. The combustor according to claim 1, wherein in that refractory chamber presents a conformation which defines the gas flow in the form of cyclone, achieving the separation of particles not combusted and ash, from the clean effluent gas stream, having a variable orientation axis where a cyclonic ash outlet is arranged at the lowest point.

3. The combustor in accordance with claim 1, wherein the air to fuel ratio between at least said two chambers is close to the stoichiometric Δ=1.

4. The combustor according to claim 1, wherein at least one chamber presents a reducing atmosphere Δ≦1, Δ=0.8 to 0.9.

5. The combustor according to claim 1, wherein at least one of the chambers provides a new dose of air to create an oxidizing atmosphere Δ≧1, Δ=1.1 to 1.2.

6. The combustor according to claims 4, wherein said chambers define the low formation of nitrogen oxides and high combustion temperature.

7. The combustor according to claim 1, wherein said combustor may be used in a thermodynamic cycle such as a Brayton cycle, a Rankine cycle, an organic Rankine cycle, and the combination thereof.

8. The combustor according to claim 1, wherein the combustor is employed in a Brayton cycle without heat exchanger, thereby defining a high thermodynamic efficiency.

9. The combustor according to claim 8, wherein a portion of the flow of the compressed gases from Bryton cycle are diverted in a bypass and mixed again before entering the turbine, allowing the control of gas temperature entering the turbine, maintaining very high gas temperature in the combustor, and achieve a low nitrogen oxide formation.

10. The combustor according to claim 1, wherein said combustion chambers are pressurized to a pressure equal to or greater than the atmospheric pressure, achieving greater volumetric efficiency at higher pressure.

11. The combustor according to claim 10, wherein the pressure is in a range between 0.25 to 0.4 MPa in a single stage of compression Brayton cycle, and from 0.8 to 1.2 MPa in double stage of compression Brayton cycle.

12. The combustor according to claim 1, wherein comprises an automatic control system to maintain system stability at different power regimes and variations in the characteristics of the biomass.

13. The combustor according to claim 12, wherein said control system is comprised of a microprocessor which controls the dosage of biomass and air flows so that the device automatically adapts to any other fuel calorific value, and with different humidity.

14. The combustor according to claim 1, wherein the biomass feed system which supplies the combustor is provided with a pellet mill at its input, creating millimeter size particles entering the combustion chamber.

15. The combustor according to claim 1, wherein the combustion chambers are built in refractory silicon nitride N2O3.

16. The combustor according to claim 1, wherein the combustion chambers built in refractory silicon nitride N2O3 are coated with zirconia ZrO2 to improve environment resistance and heat isolation.
